(19) United States
(12) Patent Application Publication
(10) Pub. No.: US 2024/0211841 A1
(43) Pub. Date: Jun. 27, 2024

(54) METHODS FOR ASSESSING AN IMPACT OF A CHANGE IN A SCENARIO ON WORKPLACE MANAGEMENT AND DEVICES THEREOF

(71) Applicant: JONES LANG LASALLE IP, INC., Chicago, IL (US)

(72) Inventors: Carlos Miranda DURAND, Chicago, IL (US); Vladimir EVTIMOV, Chicago, IL (US); Luke SPRANGERS, Chicago, IL (US); Mo DIALLO, Chicago, IL (US); Simon LEE, Chicago, IL (US)

(21) Appl. No.: 18/087,422

(22) Filed: Dec. 22, 2022

(51) Int. Cl. G06Q 10/0637; G06N 20/00

(52) U.S. Cl. CPC G06Q 10/06375; G06N 20/00

(57) ABSTRACT

Methods, non-transitory computer readable media, and an apparatus that assess an impact of a change in a scenario on workplace management include receiving an identification of a workplace environment and a selection of one of a plurality of types of scenarios associated with one of a plurality of types of workplace management machine learning models from one of a plurality of client devices. A subset of stored workplace environment data is retrieved based on the identification of the workplace environment and one or more inputs for the one of workplace management machine learning models associated with the selected one of the scenarios. One or more simulations are executed based one on more received changes in the retrieved subset of workplace environment data in the selected one of the types of workplace management machine learning models to generate a set of insight data. The generated set of insight data for the workplace environment is output to the one of the client devices.

### FIELD

This technology generally relates to predictive analytics and, more particularly, to methods for assessing an impact of a change in a scenario on workplace management and devices thereof.

### BACKGROUND

Companies require physical space for their operations, such as to house their employees, manufacturing operations and/or inventory. The costs of acquiring and maintaining this necessary physical space can be significant, especially for large or disperse organizations with a large work force. Additionally, changes to one or more scenarios because of business cycles, economics, and/or other external influencing factors, such as a pandemic, are making management of workplaces, are occurring at an increasing rate. As a result, there no longer is any effective mechanism for accurately assessing an impact of a particular change on workplace management.

### SUMMARY

A method that assesses an impact of a change in a scenario on workplace management include includes receiving, by a computing apparatus, an identification of a workplace environment and a selection of one of a plurality of types of scenarios associated with one of a plurality of types of workplace management machine learning models from one of a plurality of client devices. A subset of stored workplace environment data is retrieved, by the computing apparatus, based on the identification of the workplace environment and one or more inputs for the one of workplace management machine learning models associated with the selected one of the scenarios. One or more simulations are executed, by the computing apparatus, based one on more received changes in the retrieved subset of workplace environment data in the selected one of the types of workplace management machine learning models to generate a set of insight data. The generated set of insight data for the workplace environment is output, by the computing apparatus, to the one of the client devices

A non-transitory computer readable medium having stored thereon instructions comprising machine executable code which when executed by at least one processor, causes the processor to receive an identification of a workplace environment and a selection of one of a plurality of types of scenarios associated with one of a plurality of types of workplace management machine learning models from one of a plurality of client devices. A subset of stored workplace environment data is retrieved based on the identification of the workplace environment and one or more inputs for the one of workplace management machine learning models associated with the selected one of the scenarios. One or more simulations are executed based one on more received changes in the retrieved subset of workplace environment data in the selected one of the types of workplace management machine learning models to generate a set of insight data. The generated set of insight data for the workplace environment is output to the one of the client devices

A computing apparatus including at least one of configurable hardware logic configured to be capable of implementing or a processor coupled to a memory and configured to execute programmed instructions stored in the memory to receive an identification of a workplace environment and a selection of one of a plurality of types of scenarios associated with one of a plurality of types of workplace management machine learning models from one of a plurality of client devices. A subset of stored workplace environment data is retrieved based on the identification of the workplace environment and one or more inputs for the one of workplace management machine learning models associated with the selected one of the scenarios. One or more simulations are executed based one on more received changes in the retrieved subset of workplace environment data in the selected one of the types of workplace management machine learning models to generate a set of insight data. The generated set of insight data for the workplace environment is output to the one of the client devices

This technology provides a number of advantages including providing a method, non-transitory computer readable medium, and apparatus that accurately and cost effectively assess an impact of a change in a scenario on workplace management with a trained machine learning model. Examples of the claimed technology are able to assess a variety of different types of changes in scenarios on workplaces utilizing various unique combinations of types of stored historic data, such as workforce data, workplace data, and/or other external data on workspace data. Examples of this technology provide an automated mechanism to effectively check and provide insight data with an provided recommendation on an impact of a change in a scenario on workplace management, such as on the workspace and/or workforce, without actually implementing the change.

### BRIEF DESCRIPTION OF THE DRAWINGS

FIG. 1 is a block diagram of an example of an environment with a workspace management server configured to assess an impact of a change in a scenario on workplace management;

FIG. 2 is a block diagram illustrating examples of types of data

stored within a memory of the workspace management server;

FIG. 3 is a functional block diagram illustrating an exemplary method for training machine learning models for different types of scenarios and for assessing an impact of a change in a scenario on workplace management;

FIG. 4 is a flowchart illustrating an exemplary method for training machine learning models for different types of scenarios for workplace management;

FIG. 5 is a flowchart illustrating an exemplary method for assessing an impact of a change in a scenario on workplace management; and

FIG. 6 is are screenshots of generated insight data from an assessment.

### DETAILED DESCRIPTION

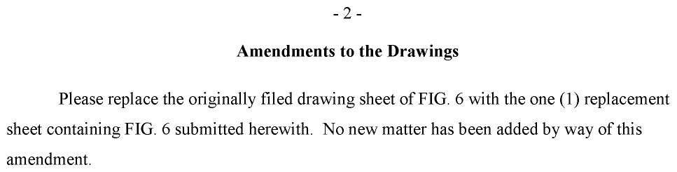

An environment 10 with an example of a workspace management server 14 is illustrated in FIGS. 1-2. In this particular example, the environment 10 includes the workspace management server 14, source data servers 12(1)-12(n), client devices 13(1)-13(n), and scenario management servers16(1)-16(n), coupled via one or more communication networks 30, although the environment could include other types and numbers of systems, devices, components, and/or other elements as is generally known in the art and will not be illustrated or described herein. This technology provides a number of advantages including providing methods, non-transitory computer readable medium, and apparatuses that accurately and cost effectively assess an impact of a change in a scenario on workplace management with a trained machine learning model.

Referring more specifically to FIGS. 1-2, the workspace management server 14 is programmed to accurately and cost effectively assess an impact of a change in a scenario on management of a workplace environment with a machine learning model trained for the scenario, although the apparatus can perform other types and/or numbers of functions or other operations and this technology can be utilized with other types of claims. In this particular example, the workspace management server 14 includes a processor 18, a memory 20, and a communication system 24 which are coupled together by a bus 26, although the workspace management server 14 may comprise other types and/or numbers of physical and/or virtual systems, devices, components, and/or other elements in other configurations.

The processor 18 in the workspace management server 14 may execute one or more programmed instructions stored in the memory 20 for assessing an impact of a change in a scenario on workplace management as illustrated and described in the examples herein, although other types and numbers of functions and/or other operations can be performed. The processor 18 in the workspace management server 14 may include one or more central processing units and/or general purpose processors with one or more processing cores, for example.

The memory 20 in the workspace management server 14 stores the programmed instructions and other data for one or more aspects of the present technology as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18, can be used for the memory 20.

As illustrated in FIG. 2, the memory 20 within the workspace management server 14 includes source data that is obtained from the plurality of source data servers 12(1)-12(n) by way of example, although the data could be obtained from other sources. In this particular example, the source data that is obtained from the plurality of source data servers 12(1)-12(n) may include: workforce data comprising human resources (HR) employee data, HR transactions data, employee work modes and places data, and employment engagement and experience data; workplace data comprising properties and facilities data, workspaces and stations data, and facility management data;

Interact data comprising digital assistants data and collaboration platform metadata; and/or other data comprising external source data, such as demographic data and job market data by way of example, and custom source data including company-employee touchpoints and real-estate data points, although the memory 20 within the workspace management server 14 can include other types or combinations of this data.

Referring back to FIG. 1, the communication system 24 in the workspace management server 14 operatively couples and communicates between the plurality of source data servers 12(1)-12(n), client devices 13(1)-13(n), and plurality of scenario management servers16(1)-16(n) which are all coupled together by one or more of the communication networks 30, although other types and numbers of communication networks or systems with other types and numbers of connections and configurations to other devices and elements. By way of example only, the communication networks 30 can use TCP/IP over Ethernet and industry-standard protocols, including NFS, CIFS, SOAP, XML,

LDAP, SCSI, and SNMP, although other types and numbers of communication networks, can be used. The communication networks 30 in this example may employ any suitable interface mechanisms and network communication technologies, including, for example, any local area network, any wide area network (e.g., Internet), teletraffic in any suitable form (e.g., voice, modem, and the like), Public Switched Telephone Network (PSTNs), Ethernet-based Packet Data Networks (PDNs), and any combinations thereof and the like.

In this particular example, each of the source data servers 12(1)-12(n) is configured to store and send data, such as workforce data, workplace data, interact data, and/or other data, although the source data servers 12(1)-12(n) can send other types and/or combinations of data. In this example, each of the source data servers 12(1)-12(n) may include a processor, a memory, and a communication system by way of example only, which are coupled together by a bus or other link, although each may have other types and/or numbers of other systems, devices, components, and/or other elements.

In this particular example, each of the client devices 13(1)-13(n) may send a request to workspace management server 14 for insight data relating to an impact of a change in a scenario on workspace management via one or more communication networks 30, although the client devices 13(1)-13(n) can send other types of requests. In this example, each of the client devices 13(1)-13(n) may include a processor, a memory, and a communication system by way of example only, which are coupled together by a bus or other link, although each may have other types and/or numbers of other systems, devices, components, and/or other elements.

Referring back to FIG. 1, the scenario management servers16(1)-16(n) may store one or more types of scenarios, such as workforce scenarios and workplace scenarios by way of example only, including factors which may be changed or adjusted in the scenarios and may communicate with the workspace management server 14 via one or more of the communication networks 30, for example, although other types and/or numbers of storage media in other configurations could be used. In this particular example, each of the scenario management servers16(1)-16(n) may comprise various combinations and types of storage hardware and/or software and represent a system with multiple network server devices in a data storage pool, which may include internal or external networks. Various network processing applications, such as CIFS applications, NFS applications, HTTP Web Network server device applications, and/or FTP applications, may be operating on the scenario management servers 16(1)-16(n) and may transmit data in response to requests from the workspace management server 14 or other devices. Each the scenario management servers16(1)-16(n) may include a processor, a memory, and a communication interface, which are coupled together by a bus or other link, although each may have other types and/or numbers of other systems, devices, components, and/or other elements.

Although the exemplary network environment 10 with the workspace management server 14, the source data servers 12(1)-12(n), client devices 13(1)-13(n), and the scenario management servers16(1)-16(n), and the communication networks 30 are described and illustrated herein, other types and numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

In addition, two or more computing systems or devices can be substituted for any one of the systems or devices in any example. Accordingly, principles and advantages of distributed processing, such as redundancy and replication also can be implemented, as desired, to increase the robustness and performance of the devices, apparatuses, and systems of the examples. The examples may also be implemented on computer system(s) that extend across any suitable network using any suitable interface mechanisms and traffic technologies, including by way of example only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples also may be embodied as a non-transitory computer readable medium having instructions stored thereon for one or more aspects of the present technology as described and illustrated by way of the examples herein, as described herein, which when executed by the processor, cause the processor to carry out the steps necessary to implement the methods of this technology as described and illustrated with the examples herein.

An example of a method for training machine learning models for different types of scenarios and for assessing an impact of a change in a scenario on workplace management will now be described with reference to FIGS. 1-6.

In particular, with reference to FIGS. 1-4, an exemplary method for training machine learning models for different types of scenarios will now be described. In this example, at steps 405 and 505 in FIGS, 3 and 4, the workspace management server 14 may retrieve a subset of stored workplace environment data for one or more workplace environments based on the particular inputs needed for each of the workplace management machine learning models associated with different scenarios from memory 20 and/or from other sources, such as one or more of the plurality of source data servers 12(1)-12(n) by way of example, for a change in one of a plurality of types of workplace scenarios. By way of further example, the workspace management server 14 may correlate different subsets of the stored historical workplace environment data based on one or more other factors or characteristics, such as grouping or otherwise identifying particular subsets of workplace data based on similar sizes of entities with stored ranges or based on geographical location(s), such as in correlated regions, by way of example only.

In this example, the subset of stored workplace environment data that is obtained includes workforce data comprising human resources (HR) employee data, HR transactions data, employee work modes and places data, and employment engagement and experience data; workplace data comprising properties and facilities data, workspaces and stations data, and facility management data; Interact data comprising digital assistants data and collaboration platform metadata; and/or other data comprising external source data, such as demographic data and job market data by way of example, and custom source data including company-employee touchpoints and real-estate data points, although other types or amounts of data can be obtained by the workspace management server 14. Training machine learning models on various workplace management scenarios using the different types of workforce data, workplace data, interact data, and other related data illustrated above, enables a highly accurate training of the machine learning models associated with workplace management of a workplace environment. In particular, in these examples the trained workplace management machine learning models enable effective proactive management of both the workplace and also the workforce for a workplace environment by providing generated insight data with clearly illustrated outcomes and recommendations.

Next, at steps 410 and 510, the workspace management server 14 may execute one or more types of processing of the retrieved subset of stored workplace environment data to facilitate application of further analytics since this data may be in a variety of different formats. In this example, the processing of the retrieved subset of stored workplace environment data may include performing data ingestion which includes converting and integrating the data obtained in different formats into a common format and removing redundant or duplicate data, although other types of processing may be executed.

Next, at steps 415 and 515, the workspace management server 14 executes an analysis of the retrieved subset of stored workplace environment data correlated to each of the machine learning models associated with different types of workplace management scenarios. In this example, the one of the machine learning models may comprise a voluntary attrition machine learning model, a retirement machine learning model, an involuntary/other machine learning model, a job change machine learning model, or a level change machine learning model, although other types and/or numbers of machine learning models or other artificial intelligence (AI) may be used. The scenario management servers16(1)-16(n) may be used to provide, edit, and otherwise manage the various workplace management scenarios which can include, by way of example, both workforce scenarios and workplace scenarios, although the scenarios can be managed in other manners.

Next at step 520, the workspace management server 14 stores the trained machine learning models for the different types of workplace management scenarios and then this exemplary method may end at step 525 or in other example may continually train the models as the stored workplace environment data changes and/or grows.

An exemplary method for assessing an impact of a change in a scenario on workplace management will now be illustrated and described with reference to FIGS. 3 and 5. In step 605, the workspace management server 14 receives an identification of a particular workplace environment, such as an identifier for a particular employer or other entity that can be correlated to a particular subset of stored workplace environment data in one or more of the data servers 12(1)-12(n) by way of example only.

Additionally, in step 605 the workspace management server 14 receives a selection of one of a plurality of types of scenarios associated with one of a plurality of types of workplace management machine learning models from one of a plurality of client devices from one of the from one of the client devices 13(1)-13(n). The workplace management server 14 may have a table or other correlation technique to associate one or more of the machine learning models for workplace management, such as a voluntary attrition machine learning model, a retirement machine learning model, an involuntary/other machine learning model, a job change machine learning model, or a level change machine learning model shown in FIG. 3 by way of example only, with the selected one or more of the scenarios. By way of example, the types of scenarios may comprise workplace scenarios, such as scenarios for consolidating office properties and locations to a larger or smaller number of locations, relocating offices, consolidating offices within a defined area, retract from markets, go to more and smaller spaces, and maintain a current footprint by way of example only, and/or workforce scenarios, such as implementation a fully remote work policy, a hybrid work policy, or fully in office work policy or a change in the number of work hours, by way of example only. These scenarios can be obtained and managed from one of the plurality of scenario management servers 16(1)-16(n), although the workspace management server 14 can obtain them from other sources.

Next, in step 610 the workspace management server 14 retrieves a subset of stored workplace environment data from one or more of the data servers 12(1)-12(n) based on the identification of the workplace environment and one or more inputs for the one of workplace management machine learning models associated with the selected one of the scenarios, although other sources and manners for obtaining the subset of stored workplace environment data can be used. The workspace management server 14 may store workplace data, workforce data, interact data and other workplace management data in data servers 12(1)-12(n) as well as data on an impact of a historic change on workplace management in one or more categories, such as cost, attrition of employees, productivity measurements, revenue impact, etc, which can be used to train different machine learning models correlated to the different types of scenarios.

These workplace data can be combined with a simulation to generate recommendations and insight as to the impact changes of the workplace data may have on the workplace in the future if certain changes are implemented or if no changes are implemented. The simulation can give information about the current workforce and then make a forecast based on various models. Different scenarios as described below and known in the art can be combined with the workplace data, workforce data, interact data and other workplace management data to generate predictions and simulations. Multiple simulations can be generated and averaged to generate a prediction of the future with no changes and with changes implemented.

Next, in steps 420 and 425 and step 615 the workspace management server 14 executes one or more simulations based one on more received changes in the retrieved subset of workplace environment data in the selected one of the types of workplace management machine learning models to generate a set of insight data along with a provided indication of a recommendation. The workspace management server 14 may generate insight data along with an indication of recommendations on workplace management and workforce management in this example, although other types of insight data along with recommendations can be provided.

By way of example, the voluntary attrition machine learning model may be trained by the workspace management server 14 on different subsets of stored workplace environment data from other workplace environments correlated based on one or more matching characteristics, such as similar size and geographic footprint within set ranges by way of example, to generate an executable algorithm for generating insight data related to a voluntary attrition scenario. The workspace management server 14 can execute simulations on that trained workplace management machine learning models on voluntary attrition based on a retrieved subset of stored workplace environment data for a current workplace environment. In these simulations, the workspace management server 14 can introduce one or more changes, such as preserving a current workplace footprint, consolidating into one office per market and reassigning employees to the nearest office, or going fully remote in NYC and Dallas office locations, to generate insight data with recommendations in different categories, such as generated insight data along with an illustrated recommendations with respect to an impact of a change in on attrition based on job role, commute times, remote working status, remote work availability, days working in the job site, job site working requirements, workplace, and criticality as shown in FIG. 6. In this example, the generated graphics clearly illustrate which of the outcomes is recommended based on the least attrition in the different categories.

By way of example, the retirement machine learning model may be trained by the workspace management server 14 on different subsets of stored workplace environment data from other workplace environments correlated based on one or more matching characteristics, such as similar size and geographic footprint within set ranges by way of example, to generate an executable algorithm for generating insight data related to a retirement scenario. The workspace management server 14 can execute simulations on that trained workplace management machine learning models on retirement based on a retrieved subset of stored workplace environment data for a current workplace environment. In these simulations, the workspace management server 14 can introduce one or more changes, such as preserving a current workplace footprint, assigning promotions and lateral movements, or going fully remote in NYC and Dallas office locations, to generate insight data with recommendations in different categories, such as generated insight data along with an illustrated recommendations with respect to an impact of a change in retirement based on job role, workplace, age, and years of service. The workspace management server 14 can execute multiple simulations based on historical behaviors of those who have left and can build a model to predict future retirement scenarios based on the characteristics of the job or age of the employees or other above changes. The results of the simulations can be averaged or combined using other methods known in the art to generate the recommendations and predictions as to a retirement scenario.

By way of example, the involuntary/other machine learning model may be trained by the workspace management server 14 on different subsets of stored workplace environment data from other workplace environments correlated based on one or more matching characteristics, such as similar size and geographic footprint within set ranges by way of example, to generate an executable algorithm for generating insight data related to an involuntary scenario. The workspace management server 14 can execute simulations on that trained workplace management machine learning models on involuntary changes based on a retrieved subset of stored workplace environment data for a current workplace environment. In these simulations, the workspace management server 14 can introduce one or more changes, such as preserving a current workplace footprint or dismissing employees based on remote working status, location, or demand, to generate insight data with recommendations in different categories, such as generated insight data along with an illustrated recommendations with respect to an impact of an involuntary change such as firing employees or laying off employees based on job role, job level, workplace, remote status, and years of service. The workspace management server 14 can execute multiple simulations based on historical behaviors of those who have left and can build a model to predict future involuntary scenarios based on the above characteristics. The results of the simulations can be averaged or combined using other methods known in the art to generate the recommendations and predictions as to an involuntary scenario.

By way of example, the job change machine learning model may be trained by the workspace management server 14 on different subsets of stored workplace environment data from other workplace environments correlated based on one or more matching characteristics, such as similar size and geographic footprint within set ranges by way of example, to generate an executable algorithm for generating insight data related to a job change scenario. The workspace management server 14 can execute simulations on that trained workplace management machine learning models on job changes based on a retrieved subset of stored workplace environment data for a current workplace environment. In these simulations, the workspace management server 14 can introduce one or more changes, such as preserving a current workplace footprint and reassigning employees to different offices, to generate insight data with recommendations in different categories, such as generated insight data along with an illustrated recommendations with respect to an impact of a job change based on job role, job level, years in current job, years in current job level, workplace, and age of employees. A young employee may be settled into a job or may be trying to learn and will not seek a job change. An older employee may be settled into their job and will not seek a job change. If an employee has multiple years in the same job or job level, then the employee may be seeking a job change. It may be difficult to have a job change depending on the job level, for example it may be easier to move between a level one and level two in a job versus an employee moving to a vice presidential position. The workspace management server 14 can execute these scenarios along with other scenarios to generate simulations based on historical behaviors of those who have sought job changes and can build a model to predict future job change scenarios based on the characteristics of the job, job level, years in current job, years in current job level, workplace, and age of employees. The results of the simulations can be averaged or combined using other methods known in the art to generate the recommendations and predictions as to job change scenarios.

By way of example, the level change machine learning model may be trained by the workspace management server 14 on different subsets of stored workplace environment data from other workplace environments correlated based on one or more matching characteristics, such as similar size and geographic footprint within set ranges by way of example, to generate an executable algorithm for generating insight data related to a level change scenario. The workspace management server 14 can execute simulations on that trained workplace management machine learning models on level changes based on a retrieved subset of stored workplace environment data for a current workplace environment. In these simulations, the workspace management server 14 can introduce one or more changes, such as preserving a current workplace footprint and reassigning employees to different offices, to generate insight data with recommendations in different categories, such as generated insight data along with an illustrated recommendations with respect to an impact of a level change based on job role, job level, years in current job, years in current job level, workplace, and age of employees. A young employee may be settled into a job or may be trying to learn and will not seek a level change. An older employee may be settled into their job and will not seek a level change. If an employee has multiple years in the same job level, then the employee may be seeking a level change. It may be difficult to have a level change depending on the current job level, for example it may be easier to move between a level one and level two in a job versus an employee moving to a vice presidential level. The workspace management server 14 can execute these scenarios along with other scenarios to generate simulations based on historical behaviors of those who have sought level changes and can build a model to predict future level change scenarios based on the characteristics of the job, job level, years in current job, years in current job level, workplace, and age of employees. The results of the simulations can be averaged or combined using other methods known in the art to generate the recommendations and predictions as to level change scenarios.

Next, in step 620 the workspace management server 14 outputs the generated set of insight data along with a provided indication of a recommendation for the workplace environment to the requesting one of the client devices 13(1)-13(n). Again, by way of example only, FIG. 6 illustrates generated insight data along with an illustrated recommendations with respect to an impact of a change in on attrition based on job role, workplace, and criticality along with portfolio footprint scenarios. Similar generated insight data can be generated for different scenarios outlined above.

This technology provides a number of advantages including

providing a method, non-transitory computer readable medium, and apparatus that effectively assists with automating an assessed predicted impact of a change in a scenario on workspace management using artificial intelligence. With this technology, an impact on workplace management, such as management of a workplace or workforce, change can be effectively and accurately determined in advance with this automated process. This technology also uniquely trains the machine learning models for different types of workplace management scenarios with different types of data, including by way of example combinations of workplace data and workforce data, to generate insights on the impact of a change along with an indication of a recommendation in manners previously not possible.

Having thus described the basic concept of the technology, it will

be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the technology. Additionally, the recited order of processing elements or sequences, or the use of numbers, letters, or other designations therefore, is not intended to limit the claimed processes to any order except as may be specified in the claims. Accordingly, the technology is limited only by the following claims and equivalents thereto.

What is claimed is:

1. A method comprising:
receiving, by a computing apparatus, an identification of a workplace environment and a selection of one of a plurality of types of scenarios associated with one of a plurality of types of workplace management machine learning models from one of a plurality of client devices;
retrieving, by the computing apparatus, a subset of stored workplace environment data based on the identification of the workplace environment and one or more inputs for the one of workplace management machine learning models associated with the selected one of the scenarios;
executing, by the computing apparatus, one or more simulations based one on more received changes in the retrieved subset of workplace environment data in the selected one of the types of workplace management machine learning models to generate a set of insight data; and
outputting, by the computing apparatus, the generated set of insight data for the workplace environment to the one of the client devices.

2. The method as set forth in claim 1 further comprising:
training, by the computing apparatus, each of the workplace management machine learning models based on the stored workplace environment data comprising at least workforce data and workplace data.

3. The method as set forth in claim 2 wherein the workforce data comprises at least human resources (HR) employee data, HR transactions data, employee work modes and places data, and employment engagement and experience data and workplace data comprises at least properties and facilities data, workspaces and stations data, and facility management data.

4. The method as set forth in claim 1 further comprising;
processing, by the computing apparatus, the retrieved subset of workplace environment data which is in two or more obtained formats into a standard format and deleting redundant data in the retrieved subset of workplace environment data prior to the executing of the one or more simulations.

5. The method as set forth in claim 1 wherein the outputting the generated set of insight data for the workplace environment further comprises:
generating, by the computing apparatus, a recommendation indication with respect to one of a plurality of options in the generated set of insight data.

6. A non-transitory computer readable medium having stored thereon instructions comprising executable code, which when executed by at least one processor, cause the processor to:
receive an identification of a workplace environment and a selection of one of a plurality of types of scenarios associated with one of a plurality of types of workplace management machine learning models from one of a plurality of client devices;
retrieve a subset of stored workplace environment data based on the identification of the workplace environment and one or more inputs for the one of workplace management machine learning models associated with the selected one of the scenarios;
execute one or more simulations based one on more received changes in the retrieved subset of workplace environment data in the selected one of the types of workplace management machine learning models to generate a set of insight data; and
output the generated set of insight data for the workplace environment to the one of the client devices.

7. The non-transitory computer readable medium as set forth in claim 6 wherein the instructions comprising the executable code, which when executed by at least one processor, further cause the processor to:
train each of the workplace management machine learning models based on the stored workplace environment data comprising at least workforce data and workplace data.

8. The non-transitory computer readable medium as set forth in claim 7 wherein the workforce data comprises at least human resources (HR) employee data, HR transactions data, employee work modes and places data, and employment engagement and experience data and workplace data comprises at least properties and facilities data, workspaces and stations data, and facility management data. 9 The non-transitory computer readable medium as set forth in claim 6 wherein the instructions comprising the executable code, which when executed by at least one processor, further cause the processor to:
process the retrieved subset of workplace environment data which is in two or more obtained formats into a standard format and deleting redundant data in the retrieved subset of workplace environment data prior to the executing of the one or more simulations.

10. The non-transitory computer readable medium as set forth in claim 6 wherein for the outputting the generated set of insight data for the workplace environment, the instructions comprising the executable code, which when executed by at least one processor, further cause the processor to:
generate a recommendation indication with respect to one of a plurality of options in the generated set of insight data.

11. A computing apparatus comprising:
a processor; and
a memory coupled to the processor which is configured to be capable of executing programmed instructions comprising and stored in the memory to:
receive an identification of a workplace environment and a selection of one of a plurality of types of scenarios associated with one of a plurality of types of workplace management machine learning models from one of a plurality of client devices;
retrieve a subset of stored workplace environment data based on the identification of the workplace environment and one or more inputs for the one of workplace management machine learning models associated with the selected one of the scenarios;
execute one or more simulations based one on more received changes in the retrieved subset of workplace environment data in the selected one of the types of workplace management machine learning models to generate a set of insight data; and
output the generated set of insight data for the workplace environment to the one of the client devices.

12. The apparatus as set forth in claim 11 wherein the processor is further configured to be capable of executing the stored programmed instructions to:
training, by the computing apparatus, of the plurality of types of workplace management machine learning models based on the stored workplace environment data comprising at least workforce data and workplace data.

13. The apparatus as set forth in claim 12 wherein the workforce data comprises at least human resources (HR) employee data, HR transactions data, employee work modes and places data, and employment engagement and experience data and workplace data comprises at least properties and facilities data, workspaces and stations data, and facility management data.

14. The apparatus as set forth in claim 11 wherein the processor is further configured to be capable of executing the stored programmed instructions to:
process the retrieved subset of workplace environment data which is in two or more obtained formats into a standard format and deleting redundant data in the retrieved subset of workplace environment data prior to the executing of the one or more simulations.

15. The non-transitory computer readable medium as set forth in claim 11 wherein for the outputting the generated set of insight data for the workplace environment, the processor is further configured to be capable of executing the stored programmed instructions to:
generate a recommendation indication with respect to one of a plurality of options in the generated set of insight data.
